(19) United States
(12) Patent Application Publication
(10) Pub. No.: US 2025/0165755 A1
(43) Pub. Date: May 22, 2025

(54) Data Leak Detection in Generative Artificial Intelligence Model Output

(71) Applicant: Bank of America Corporation, Charlotte, NC (US)

(72) Inventors: Carrie Elaine Gates, Livermore, CA (US); Jason Strarin, Huntersville, NC (US)

(73) Assignee: Bank of America Corporation, Charlotte, NC (US)

(21) Appl. No.: 18/518,182

(22) Filed: Nov. 22, 2023

(51) Int. Cl. G06N 3/0475

(52) U.S. Cl. CPC G06N 3/0475

(57) ABSTRACT

Aspects of the disclosure relate to detection of confidential information used in generative artificial intelligence platforms. An artificial intelligence computing platform having at least one processor, a memory, and a communication interface may generate questions and ask other generative artificial intelligence platforms the generated questions to determine if the other generative artificial intelligent platforms answers indicate that restricted access, confidential, or proprietary information data has been leaked and disseminated. In an embodiment, prompt injection may be used to determine if external generative artificial intelligence platforms are utilizing an enterprises confidential or proprietary information. A computing platform may transmit, via the communication interface, to an administrative computing device, information regarding the unauthorized dissemination which, when processed by the administrative computing device causes a notification to be displayed on the administrative computing device.

### BACKGROUND

Aspects of the disclosure relate to electrical computers, digital processing systems, and generative artificial intelligence platforms. In particular, one or more aspects of the disclosure relate to detecting use of restricted access, confidential, or proprietary data used by artificial intelligence platforms.

As artificial intelligence systems are increasingly utilized to provide output and even decisions, such computer systems may obtain increasing amounts of various types of confidential or proprietary information. For example, increased use of generative artificial intelligence systems may give rise to threats of leaked proprietary organizational data used to generate output by such systems. Currently, it is difficult to determine if generative artificial intelligence platforms have used confidential or proprietary information in generating requested output. Therefore, there is a need to be able to detect the unauthorized use of confidential and proprietary information by generative artificial intelligence systems to produce output.

### SUMMARY

Aspects of the disclosure provide effective, efficient, scalable, and convenient technical solutions that address and overcome the technical problems associated with providing information security and optimizing the efficient and effective technical operations of computer systems. In particular, one or more aspects of the disclosure provide techniques for improving information security and enhancing technical performance of computing systems.

In accordance with one or more embodiments, a computing platform having at least one processor, a memory, and a communication interface may generate questions for a generative artificial intelligence platform to determine if there has been unauthorized dissemination of a confidential data file. The identification of a unique identifying feature in response by generative artificial intelligence platform to generated questions may correspond to an unauthorized dissemination of a data file.

The computing platform upon detection of an unauthorized dissemination of confidential data file, may transmit via the communication interface, to an administrative computing device, an unauthorized dissemination alert which, when processed by the administrative computing device causes a notification to be displayed on the administrative computing device. The notification may identify the generative artificial intelligence platform on which the data file was discovered and any access information associated with the data file.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A depicts an illustrative computing environment for determining if generative artificial intelligence platforms are using an entities confidential information in accordance with one or more example embodiments;

FIG. 1B depicts an artificial intelligence question generation computing platform for generating questions for detection of unauthorized use of confidential data files in accordance with one or more example embodiments;

FIG. 2 depicts an illustrative method for detecting if generative artificial intelligence platforms are using an entities confidential information in accordance with one or more example embodiments; and

FIGS. 3 and 4 depict example graphical user interfaces for administrative computing devices in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Organizations and individual users are using artificial intelligence to assist in improving drafted documents, improving numerous process flows, and solving difficult data intense problems. Artificial intelligence platforms scrape worldwide websites for information to be cataloged and use the scraped information for answering any asked question or solving presented problems. Artificial intelligence platforms are also fed information in bulk as training sets to improve accuracy of responses. Currently, confidential and proprietary data can be accidentally or intentionally used in these platforms without consent or knowledge of owners of the confidential or proprietary information.

The risk of unauthorized disclosure of sensitive information through use of generative artificial intelligence is great and is extremely difficult to detect. The following description describes illustrative embodiments that assists parties in determining if confidential and proprietary information was used to produce output or responses by generative artificial intelligence platforms.

In accordance with one or more aspects disclosed herein, data files distributed to a plurality of users may each contain a unique identifying feature (e.g., watermark or identifiable feature) that enables an enterprise organization to identify a potential “leaked” copy of a data file. In some examples, the unique identifying feature is invisible to the naked eye. For example, the font of a single character in a document may be altered, spacing between two words may be altered, and/or other subtle changes may be made so that the unique identifying feature is entirely unapparent to the user. Having the unique identifying feature invisible to the naked eye enhances security by minimizing the risk that even a sophisticated user will obfuscate the unique identifying feature.

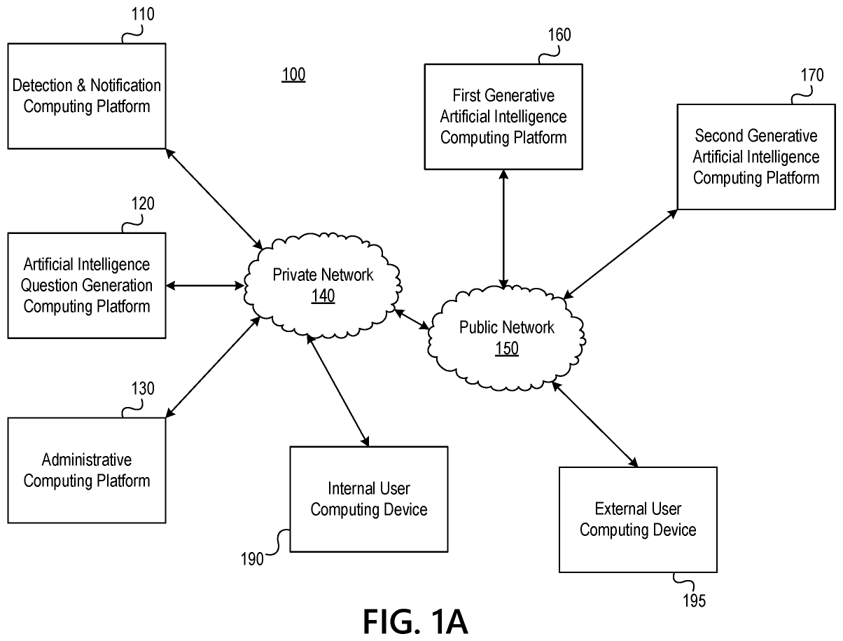

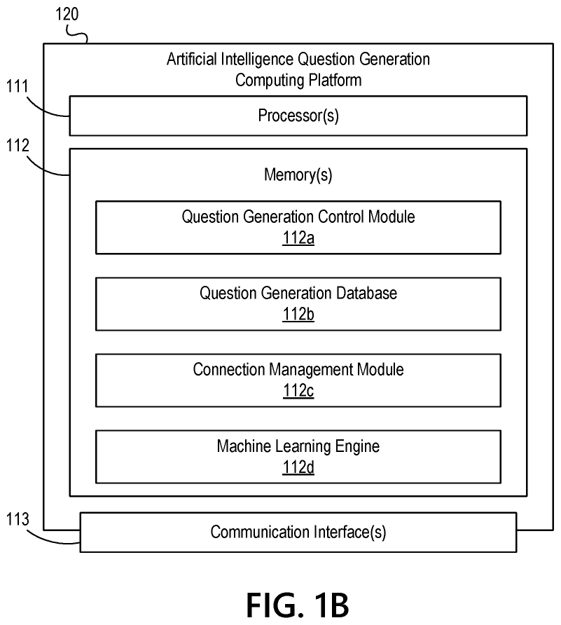

FIGS. 1A and 1B depict an illustrative computing environment detecting unauthorized dissemination of data files to generative artificial intelligence platforms. Referring to FIG. 1A, computing environment 100 may include one or more computer systems, one or more computer networks, and/or other computing infrastructure. For example, computing environment 100 may include a detection and notification computing platform 110, an artificial intelligence question generation computing platform 120, an administrative computing platform 130, a private network 140, a public network 150, a first generative artificial computing platform 160, a second generative artificial computing platform 170, a internal user computing device 190, and a external user computing device 195.

As discussed in greater detail below, detection and notification computing platform 110 may include one or more computing devices configured to perform one or more of the functions described herein. For example, detection and notification computing platform 110 may include one or more computers (e.g., laptop computers, desktop computers, servers, server blades, or the like) that are configured to orchestrate detection and notification operations across multiple computer systems and devices in computing environment 100.

Artificial intelligence question generation computing platform 120 may include one or more computing devices configured to generate questions to ask external generative artificial intelligence platforms 160 and 170. The questions generated may be used to determine if an enterprises confidential information has been leaked or compromised in some manner. The questions may be in the form of a series of questions that are generated to determine if any non-public personal information (i.e. names, addresses income information, social security numbers, account numbers, payment histories, vendor information etc.) or confidential proprietary information (i.e. source code, trade secrets etc.) has been breached and used by any external generative artificial intelligence platforms. The questions may be updated or replaced by different questions in real-time based on the output received from the external generative artificial intelligence platforms responses.

The questions generated by artificial intelligence question generation computing platform 120 may be based on embedded unique identifying features inserted into data files by administrative computing platform 130. For instance, administrative computing platform 130 may use pieces of data found in a data file that are not non-public personal information to generate a unique identifying feature and insert the generated feature into the data file. The inserted unique identifying feature may be known only to the enterprise and could be used by detection and notification computing platform 110. Based on received output from an external generative artificial intelligence platform 160 and/or 170, detection and notification computing platform 110 may determine if any unique identifying feature is present in the received output. Detection of a unique identifying feature may indicate that a corresponding data file has been compromised.

Unique identification features may include various combinations of data included in the data file or associated with the data file. For instance, unique identification features for a data file may be generated from a combination of the stored data's form, format, and/or function.

In an embodiment, enterprise confidential information may be accidently leaked by an internal user using unauthorized external generative artificial intelligence models to obtain summaries of existing documents that contain confidential information. Use of unauthorized external generative artificial intelligence models may without proper guardrails in place end up leaking confidential information into the public domain.

Currently, generative artificial intelligence platforms use search engines APIs to scan and collect information on the Internet. Screen scraping or spidering may be used by generative artificial intelligence platforms to read webpages in text format and catalog the information into text maps for aiding in searching. In an embodiment, prompt injection may be used to determine if external generative artificial intelligence platforms are utilizing an enterprises confidential or proprietary information. For instance, an indirect prompt injection instruction may be included in enterprise data files that instructs a generative artificial intelligence computing platform to provide a partial answer or portion of an answer if answering specific questions. An indirect prompt injection instruction may be placed in a data file that instructs an external generative artificial intelligence platform to include a certain word as part of its output to specific questions. For instance, the indirect prompt injection instruction may be to include the word “Llama” in its output when asked a specific question regarding access to an entities financial account information.

In another embodiment, an indirect prompt injection instruction may include an instruction to generate and transmit an email to a specific email address if the answer by an external generative artificial intelligence platform to specific questions includes or uses confidential or proprietary information to generate the answer. The receipt of the email to the identified address may indicate that the data file has been leaked or compromised.

In yet another embodiment, an indirect injection prompt instruction may include an instruction to the generative artificial intelligence platform to provide answers in a particular format. Detection of answers from the generative artificial intelligence using the specified format may indicate data file leakage.

In an aspect of the disclosure, unique identifying features embedded into data files may be text phrases or fake accounts. A confidential general ledger may include embedded text phrases that are undetectable to a human eye. For instance, a general ledger may include an embedded text phrase such as “Llama is hungry” or “Llama wants food.” Detection of such phrases in response to generated questions answered by generative artificial intelligence platforms would indicate a general ledger that may have been compromised. Similarly, fake accounts with specific names and criteria may also be imbedded as unique identifying features to detect unauthorized data file leakage. Detection of the information in answers generated by the generative artificial intelligence platform may indicate data file leakage.

In another aspect of the disclosure, a honeypot account may be embedded into a data file having pages of account information. The honeypot account may be used to assist in capturing information on entities that are trying to comprise an organizations data. The honeypot account may include a name and associated email address. The honeypot account may also include an instruction set to be executed. Detection of the honeypot account in answers generated by the generative artificial intelligence platform may indicate data file leakage.

In yet another embodiment of the disclosure, multiple indirect prompt injection instructions may be embedded in data files. One instruction set may assist in determining if a data file has been leaked and the other instruction set may determine when a data file access has occurred.

In an embodiment, a hex string stamp may be placed in the header of source code files when deposited into a code repository. The hex string stamp may be unknown to those working with the code. The hex string stamp may be equal to a static variable. For example, “Llama” may be added as the variable at the top of the file. The hex string may equal the Llama variable. The Llama variable may not be used anywhere in the source code body and only inserted at the top of the file in the declaration of that variable. A generative artificial intelligence platform may find and analyze the hex string and convert it to plain text. In another embodiment, the hex string may be an executable with an instruction to email home with a statement that includes a message that this data or source code belongs to X organization and provide notification that it is been detected at a particular location.

Internal user computing device 190 and the external user computing device 195 may be a desktop computer, laptop computer, workstation, or other computing device that is configured to be used by a user. Administrative computing platform 130 may be a desktop computer, laptop computer, workstation, or other computing device that is configured to be used by an administrative user, such as a network administrator associated with an organization operating detection and notification control computing platform 110 and/or artificial intelligence question generation computing platform 120.

External generative artificial computing platforms 160 and 170 may include one or more computing devices configured to provide users or organizations with generative artificial intelligence platform services. In some embodiments, the generative artificial intelligence platform services may include generated text, voice, and/or images. In some instances, generative artificial computing platforms 160 and 170 may be private subscription services or open source platforms. In embodiment, each platform may maintain user profile information for users of generative artificial computing platforms 160 and 170.

Computing environment 100 also may include one or more networks, which may interconnect one or more of detection and notification computing platform 110, artificial intelligence question generation computing platform 120, administrative computing platform 130, external generative artificial intelligence computing platforms 160 and 170, internal user computing device 190, and external user computing device 195. For example, computing environment 100 may include private network 140, which may be owned and/or operated by a specific organization and/or which may interconnect one or more systems and/or other devices associated with the specific organization. For example, detection and notification computing platform 110, artificial intelligence question generation computing platform 120, administrative computing platform 130, and internal user computing device 190 may be owned and/or operated by a specific organization, such as a financial institution, and private network 140 may interconnect detection and notification computing platform 110, artificial intelligence question generation computing platform 120, administrative computing platform 130, internal user computing device 190 and one or more other systems and/or devices associated with the organization. Additionally, private network 140 may connect (e.g., via one or more firewalls) to one or more external networks not associated with the organization, such as public network 150. Public network 150 may, for instance, include the Internet and may connect various systems and/or devices not associated with the organization operating private network 140. For example, public network 150 may interconnect external generative artificial intelligence computing platforms 160 and 170, external user computing devices 195, and/or various other systems and/or devices.

In some arrangements, the computing devices that make up and/or are included in detection and notification platform 110, artificial intelligence question generation computing platform 120, administrative computing platform 130, external generative artificial intelligence computing platforms 160 and 170, user computing device 190, and external user computing device 195 may be any type of computing device capable of receiving a user interface, receiving input via the user interface, and communicating the received input to one or more other computing devices. For example, the computing devices that make up and/or are included in the above may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of the computing devices that make up and/or are included in the above may, in some instances, be special-purpose computing devices configured to perform specific functions.

Referring to FIG. 1B, artificial intelligence question generation computing platform 120 may include one or more processor(s) 111, memory(s) 112, and communication interface(s) 113. A data bus may interconnect processor(s) 111, memory(s) 112, and communication interface(s) 113. Communication interface(s) 113 may be one or more network interfaces configured to support communications between artificial intelligence question generation computing platform 120 and one or more networks (e.g., private network 140, public network 150). For example, artificial intelligence question generation computing platform 120 may establish one or more connections and/or communication links to one or more other systems and/or devices (e.g., detection and notification computing platform 110, administrative computing platform 130, external generative artificial intelligence computing platforms 160 and 170, and user computing devices 190 and 195) via communication interface(s) 113, and artificial intelligence question generation computing platform 120 may exchange data with the one or more other systems and/or devices (e.g., detection and notification computing platform 110, administrative computing platform 130, external generative artificial intelligence computing platforms 160 and 170, and user computing devices 190 and 195) via communication interface(s) 113 while the one or more connections and/or communication links are established. Memory(s) 112 may include one or more program modules having instructions that when executed by processor(s) 111 cause artificial intelligence question generation computing platform 120 to perform one or more functions described herein and/or one or more databases that may store and/or otherwise maintain information which may be used by such program modules and/or processor(s) 111. In some instances, the one or more program modules and/or databases may be stored by and/or maintained in different memory units and/or by different computing devices that may form and/or otherwise make up artificial intelligence question generation computing platform 120.

For example, memory(s) 112b may have, store, and/or include a question generation control module 112a, a question generation database 112b, a connection management module 112c, and a machine learning engine 112d. Artificial intelligence question generation control module 112a may have, store, and/or include instructions that direct and/or cause artificial intelligence question generation computing platform 120 to orchestrate operations across multiple computer systems and devices in computing environment 100 and perform other associated functions, as discussed in greater detail below. Question generation database 112b may store information used by detection and notification control computing platform 110 in detection and notification operations across multiple computer systems and devices in computing environment 100 and in performing other associated functions. Connection management module 112c may have, store, and/or include instructions that direct and/or cause detection and notification control computing platform 110 to establish one or more connections and/or communication links to one or more other systems and/or devices (e.g., artificial intelligence question generation computing platform 120, administrative computing platform 130, generative artificial computing platforms 160 and 170, and user computing devices 190 and 195) via communication interface(s) 113 and/or to manage and/or otherwise control the exchanging of data with the one or more other systems and/or devices.

Machine learning engine 112d may have, store, and/or include instructions that direct and/or cause generation of questions for generative artificial intelligence platforms to determine if data files include unique identifying features. Machine learning engine 112d may dynamically analyze data collected by detection and notification computing platform 110. Machine learning engine 112d may also analyze historical data sets and/or present operations and automatically optimize the functions provided by detection and notification computing platform 110 based on analyzing such data.

In some examples, machine learning engine 112d may include one or more supervised learning models (e.g., decision trees, bagging, boosting, random forest, neural networks, linear regression, artificial neural networks, logical regression, support vector machines, and/or other models), unsupervised learning models (e.g., clustering, anomaly detection, artificial neural networks, and/or other models), knowledge graphs, simulated annealing algorithms, hybrid quantum computing models, and/or other models. In some examples, training the machine learning engine 112d may include training the model using labeled data and/or unlabeled data.

In some examples, a dynamic feedback loop may be used to continuously update or validate machine learning engine 112d. For instance, access data of confidential data files, user authorization rights of confidential data files, and the like, may be used to update or validate the model to improve accuracy of data leak detection.

Administrative computing device 130 may transmit to the detection and notification computing platform 110 business rules or other information that identifies restricted-access data files and/or criteria used for determining whether a data file may contain restricted-access content.

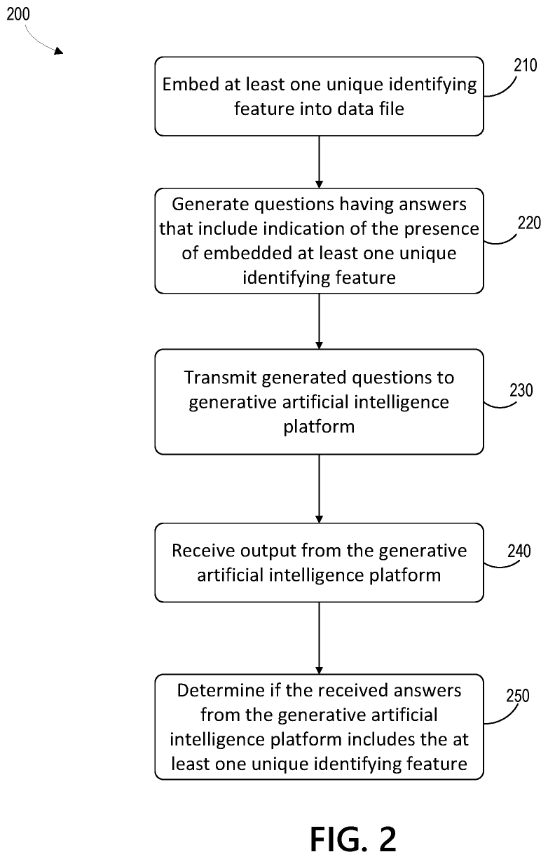

FIG. 2 depicts an illustrative method for detecting if generative artificial intelligence platforms are using an entities confidential information in accordance with one or more example embodiments. In FIG. 2 at step 210, the computing platform may embed at least one unique identifying feature into a data file that includes confidential information. In step 220, the computing platform may generate questions to be directed to an external generative artificial intelligence platform. The generated questions may have been created by an artificial intellection platform having knowledge of unique features contained in an entities confidential data files. The answers to the generated questions may indicate the presence of the embedded at least one unique identifying feature.

In step 230, the computing platform may transmit, via the communication interface, to the generative artificial intelligence platform the generated questions. In step 240, the computing platform may receive, via the communication interface, output from the generative artificial intelligence, the output including answers to the transmitted generated questions.

In step 250, the computing platform may determine whether the received answers from the generative artificial intelligence platform include the at least one unique identifying feature. The at least one unique identifying feature may be used to determine a compromised data file. Upon identifying unauthorized access to a data file, the computing platform may notify entities regarding the unauthorized dissemination.

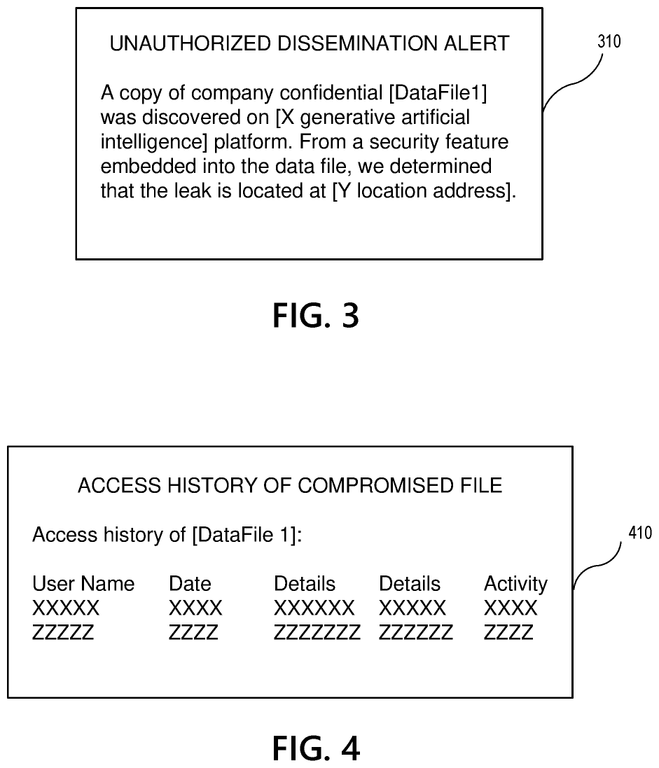

FIGS. 3 and 4 illustrate examples of graphical user interfaces for administrative computing device 130. FIG. 3 shows an interface 310 that may alert the enterprise organization of the unauthorized dissemination (“leak”) of a particular data file. The notification 310 may identify, for example, the generative artificial intelligence platform associated with the unauthorized dissemination. The notification may also include a destination location address of the leak, if determined.

FIG. 4 illustrates an example of an interface 410 that may alert the enterprise organization to the particular access history of the leaked data file. Review of the access history for the leaked data file may assist in determining if any user accounts or other data files may need to be blocked as a result of the detected unauthorized dissemination.

The particular user interfaces shown in FIGS. 3 and 4 are merely illustrative and may be customized depending on user preferences as well as the type of device being used. For example, user interfaces on a smartphone or other telephone-enabled device may include an option to call another entity associated with the computing platform, e.g., other user(s) and/or administrator(s). User interfaces may include other desired functionality, such as an option to send a message to other user(s) or administrator(s).

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform, comprising:
at least one processor;
a communication interface communicatively coupled to the at least one processor; and
memory storing computer-readable instructions that, when executed by the at least one processor, cause the computing platform to:
embed at least one unique identifying feature into a data file that includes confidential information;
generate questions to be directed to a generative artificial intelligence platform, the generated questions having answers that indicate the presence of the embedded at least one unique identifying feature;
transmit, via the communication interface, to the generative artificial intelligence platform the generated questions;
receive, via the communication interface, output from the generative artificial intelligence, the output including answers to the transmitted generated questions; and
determine whether the received answers include the at least one unique identifying feature.

2. The computing platform of claim 1, wherein the memory stores additional computer-readable instructions that, when executed by the at least one processor, cause the computing platform to:
transmit, via the communication interface, to an administrative computing device, detection of the at least one unique identifying feature; and
determine the compromised data file associated with the at least one unique identifying feature.

3. The computing platform of claim 2, wherein the memory stores additional computer-readable instructions that, when executed by the at least one processor, cause the computing platform to determine access history of the compromised data file.

4. The computing platform of claim 1, wherein the data file is tagged as restricted-access.

5. The computing platform of claim 1, wherein the data file that includes confidential information includes non-public priority information.

6. The computing platform of claim 1, wherein the at least one unique identifying feature embedded in the data file comprises a font change to one or more characters, one or more changes in spacing between adjacent characters, or one or more changes to spacing between adjacent lines of text.

7. The computing platform of claim 7, wherein the at least one unique identifying feature embedded in data file is essentially undetectable by the human eye.

8. The computing platform of claim 1, wherein the at least one unique identifying feature embedded in data file includes an injection command.

9. A method, comprising:
at a computing platform comprising at least one processor, memory, and a communication interface:
embedding at least one unique identifying feature into a data file that includes confidential information;
generating questions to be directed to a generative artificial intelligence platform, the generated questions having answers that indicate the presence of the embedded at least one unique identifying feature;
transmitting, via the communication interface, to the generative artificial intelligence platform the generated questions;
receiving, via the communication interface, output from the generative artificial intelligence, the output including answers to the transmitted generated questions; and
determining whether the received answers include the at least one unique identifying feature.

10. The method of claim 9, further comprising:
transmitting, via the communication interface, to an administrative computing device, detection of the at least one unique identifying feature; and
determining the compromised data file associated with the at least one unique identifying feature.

11. The method of claim 10, further comprising determining access history of the compromised data file.

12. The method of claim 9, wherein the data file is tagged as restricted-access.

13. The method of claim 9, wherein the data file that includes confidential information includes non-public priority information.

14. The method of claim 9, wherein the at least one unique identifying feature embedded in the data file comprises a font change to one or more characters, one or more changes in spacing between adjacent characters, or one or more changes to spacing between adjacent lines of text.

15. The method of claim 9, wherein the unique identifying feature of the data file is essentially undetectable by the human eye.

16. One or more non-transitory computer-readable media storing instructions that, when executed by a computing platform comprising at least one processor, memory, and a communication interface, cause the computing platform to:
embed at least one unique identifying feature into a data file that includes confidential information;
generate questions to be directed to a generative artificial intelligence platform, the generated questions having answers that indicate the presence of the embedded at least one unique identifying feature;
transmit, via the communication interface, to the generative artificial intelligence platform the generated questions;
receive, via the communication interface, output from the generative artificial intelligence, the output including answers to the transmitted generated questions; and
determine whether the received answers include the at least one unique identifying feature.

17. The non-transitory computer-readable media of claim 16, wherein the computer-readable instructions, when executed by the at least one processor, cause the computing platform to:
transmit, via the communication interface, to an administrative computing device, detection of the at least one unique identifying feature; and
determine the compromised data file associated with the at least one unique identifying feature.

18. The non-transitory computer-readable media of claim 17, wherein the computer-readable instructions, when executed by the at least one processor, cause the computing platform to determine access history of the compromised data file

19. The non-transitory computer-readable media of claim 16, wherein the data file is tagged as restricted-access.

20. The non-transitory computer-readable media of claim 16, wherein the at least one unique identifying feature embedded in the data file comprises a font change to one or more characters, one or more changes in spacing between adjacent characters, or one or more changes to spacing between adjacent lines of text.
